(19) United States
(12) Patent Application Publication
(10) Pub. No.: US 2012/0038451 A1
(43) Pub. Date: Feb. 16, 2012

(54) ELECTRICAL FUSE

(76) Inventors: Claudia Voigt, Rothenbach (DE); Hans-Jürgen Schreiner, Neukirchen am Sand-Rollhofen (DE); Alfons Kelnberger, Bamberg (DE)

(21) Appl. No.: 13/202,104

(22) PCT Filed: Feb. 26, 2010
(86) PCT No.: PCT/EP10/52454

§ 371 Date: Aug. 29, 2011

(30) Foreign Application Priority Data
Feb. 27, 2009 (DE) 10 2009 001 210.9
Oct. 7, 2009 (DE) 10 2009 045 412.8

(51) Int. Cl. H01H 85/143; H01H 69/02

(52) U.S. Cl. 337/188; 29/623

(57) ABSTRACT

A method for producing an electrical fuse, in particular a fusible link, with electrically conducting materials which are enclosed by electrically insulating materials, and with electrically conducting terminal elements on the electrically conducting materials.

The invention relates to a method for producing an electrical fuse, in particular a fusible link, according to the preamble of claim 1, an electrical fuse, and a blank for producing a fuse.

The present prior art in the field of fusible links is constituted by so-called fine-wire fuses that consist, for example, of a small glass or ceramic tube with metal caps at both ends, between which the fusible element or fusible wire is located. This fusible wire is exposed or embedded in quartz sand. These fuses are often also referred to as flicker-tube fuses or glass-tube fuses.

Prior art is also constituted by flat plug fuses which are only used for low voltages and mainly in motor vehicles. Common embodiments are the standard flat fuse and the mini-flat fuse. Variants without housings for employment in terminal screws are also in use. These are metal elements with impressed nominal current value.

The underlying object of the invention is to specify an electrical fuse, in particular a fusible link, that reliably protects electrical. switching circuits from overloading, yet can be produced with substantially less outlay and thus considerably lower costs than common fuse types.

In accordance with the invention this object is achieved by means of the features of claim 1.

By virtue of the fact that by means of an extrusion process a continuous blank is produced from the electrically conducting and electrically insulating materials and after the extrusion process the blank is cut to the desired length and provided with the terminal elements before or after curing, cooling or drying, on the one hand the electrical fuse is reliably protected from overloading and on the other hand it can be produced simply and as a result at a low cost.

The extrusion process is preferably a coextrusion process.

In comparison with the prior art, a completely new and inventive concept has been developed for an electrical fuse based on a single- or multi-stage polymer base. This concept makes it possible to produce the fuse almost completely in a so-called extrusion process.

Current research work has shown that it is possible to bring materials that have different properties into shape simultaneously and. in a defined manner by means of extrusion, with these materials being embedded in suitable matrices of organic material.

These methods are referred to as coextrusion and very clearly are comparable with that of pressing out multi-coloured toothpaste. As a result, it is possible to obtain, for example, long, cylindrical components that have different properties across their diameter.

If materials that are electrically insulating and electrically conducting are combined in this coextrusion process, in accordance with the invention electrical fuse components, for example electrical fine-wire fuses, can be produced thereby.

A conductive phase that is enclosed by an electrically insulating phase is specifically located in the centre of the extrudate.

The conductive phase represents the conventional fuse-link wire, and the electrically insulating phase replaces the conventional ceramic or glass body.

A typical run could be as follows: the two basic substances—also referred to as feedstocks—are prepared in accordance with the prior art and conveyed by means of suitable extrusion machines so that a conductive phase that is enclosed. by an electrically insulating phase develops in the centre of the extrudate.

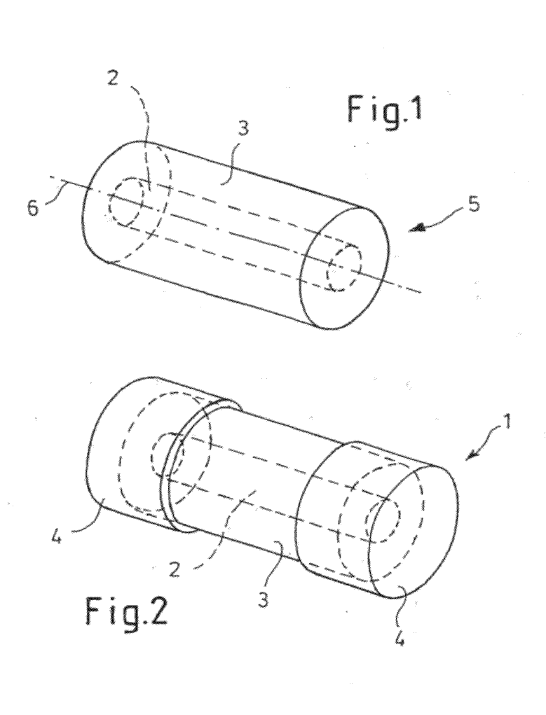

After a suitable drying process that is to be matched to the organic constituents, a composite material develops that can easily be separated into defined portions and is provided at the two end faces with. suitable, electrically conducting terminals in the form of caps or sleeves (see FIGS. 1 and 2).

If a current flows through this arrangement, depending on the dimensioning of the conductive phase a situation can be reached where this phase melts in the case of a defined electrical overload, and the conductivity is interrupted.

During normal operation, current flows through this component which is integrated in an electrical switching circuit, the current being insulated from the remaining constituents of the system by the outer phase.

The classic function of a fuse can be presented with the concept in accordance with the invention.

Advantageously, this outer insulating phase is filled with thermally conducting ceramic particles—for example Al₂O₃, ZrO₂, SiO₂, AlN or a combination that ensures that during normal operation the resultant heat is effectively dissipated outwards.

The spectrum of organic substances that can be used and serve as carrier material for the functional materials is wide-ranging, and selections can be made from the prior art depending on the requirement.

Materials that are resistant to high temperatures, for example PEEK, Teflon derivates or polyethylene (PE), such as e.g. high-density (HD) PE or low-density (LD) PE, are suitable for the fuses in accordance with the invention.

All common electrically conductive substances, for example metal particles, such as e.g. copper, silver, gold, or even conductive ceramic materials, such as e.g. titanium nitrides, cuprates, silicon carbides, vet also materials made from carbon or similar, can be used as the conductive phase in the core zone.

When powders are used, the filling level will lie considerably above the percolation threshold, so that the electrical conductivity is ensured.

In a further variant it is also conceivable for conductive metal wires that have a defined resistance to be integrated in the extrusion process so that cable-like components develop as fine-wire fuses.

Electrically conductive polymers that realize the function of the fusible wire in the classic sense are equally possible.

An important advantage of the invention lies in the fact that the filling level of the functional materials permits continuous matching of the conducting or insulating properties of the fuse.

In the sense of the fuses in accordance with the invention of course multi-component composites are also possible. For example, phases can also be used between the inner conductive phase and the outer insulating phase that quickly terminate the melting of the conductive phase in the case of overloading. This could be a polymer phase filled with quartz sand, for example.

However, one advantage of the invention nonetheless also lies just in the fact that it is possible to dispense with an additional third phase, since the desired electrical and thermal properties can after all be adjusted by means of the targeted admixture of functional materials in the outer phase.

A further key advantage of the invention lies in the functionality of the fuse that can easily be detected visually, since after all the outer polymer layer melts in the case of overloading. The classic extra-fine-wire fuses made from ceramic material do not afford this advantage; it is not possible to identify with the naked eye whether these fuses are still in order.

A further advantage is that conditional on the production process no hollow spaces develop. The fuse is intrinsically tight and protected against water or other moisture.

Another advantage lies in the fact that after all an overload can not only exist electrically; it can also originate from external overheating. Here an additional fuse mechanism. exists, since here as well the fuse melts down and protects the whole system.

The invention is explained further in the following with the aid of the claims.

In an inventive development, the electrically conducting materials are arranged on the longitudinal axis of the blank and of the subsequent fuse and are surrounded coaxially by the electrically insulating materials. The extrusion process is simplified as a result.

In a further inventive development, plastics materials, to which suitable additives are added, are used for the electrically conducting and electrically insulating materials. Plastics materials are eminently suitable for the extrusion process and can easily be provided with additives. Generally, polymers are also understood by plastics materials.

In an inventive development, electrically conductive materials are added to the plastics materials so that they become electrically conducting. The number, the parts by volume or the concentration of the electrically conductive materials determines the resistance of the conductive phase.

Metal particles made from copper, silver, gold or even conductive ceramic materials, such as e.g. titanium nitrides, cuprates, silicon carbides, yet also materials made from carbon are preferably used for the electrically conductive materials.

Electrically conductive powder can also be used for the electrically conductive metal particles.

Thermally conducting ceramic particles can be added to the electrically insulating plastics materials for better heat dissipation.

In an inventive development, Al₂O₃, ZrO₂, SiO₂, AlN or a combination of these are used as the thermally conducting ceramic particles.

Materials that are resistant to high temperatures, such as PEEK, Teflon derivates or polyethylene (PE), such as e.g. high-density (HD) PE or low-density (LD) PE, are preferably used for the electrically insulating plastics materials.

Multi-component composites can also be used for the plastics materials.

In an embodiment, a plastics material that is filled with quartz sand is used for the electrically insulating plastics materials.

In an inventive development, materials are used that terminate the melting of the conductive materials and plastics materials in the case of overloading. This self-extinguishing function is particularly advantageous in devices/machines in which no combustion may result under any circumstances.

An electrical fuse in accordance with the invention having electrically conducting materials that are enclosed by electrically insulating materials and having electrically conducting terminal elements to the electrically conducting materials is preferably distinguished by virtue of the fact that the materials are plastics materials, to which electrically conducting and/or thermally conducting additives are added.

The invention also describes a blank for producing an electrical fuse with electrically conducting materials that are enclosed by electrically insulating materials for subsequent assembly and supplementation with electrically conducting terminal elements to the electrically conducting materials. The materials are in accordance with the invention plastics materials, to which electrically conducting and/or thermally conducting additives are added.

FIGS. 1 and 2 show the basic structure of a two-phase fuse in accordance with the invention with and without end caps.

FIG. 1 shows a blank 5 in accordance with the invention for producing an electrical fuse. The blank 5 has been produced by means of an extrusion process from two plastics materials. Arranged in the interior of the blank 5, that is, on its longitudinal axis 6, there is the electrical phase. This consists of a plastics material with electrically conducting additives. This electrical phase is surrounded coaxially by an electrically insulating phase 3. The electrically insulating phase 3 also consists of a plastics material, to which thermally conducting ceramic particles are added for better thermal dissipation. The blank is manufactured continuously by means of the extrusion process and subsequently dried and cut to the desired length. Subsequently, the blank is provided with electrically conducting terminal elements 4 to the electrically conducting materials 2 in the form of end caps.

FIG. 2 shows the finished electrical fuse 1, that is, the blank 5 of FIG. 1 provided with electrically conducting terminal elements 4 in the form of end cabs.

1-14. (canceled)

15. A method for producing an electrical fuse with electrically conducting materials, enclosed by electrically insulating materials, and with electrically conducting terminal elements to the electrically conducting materials, by extruding a continuous blank produced from an electrically conducting materials and an electrically insulating materials and after the extrusion process cutting the continuous blank to a desired length, and providing terminal elements before or after at least one of curing, cooling or drying.

16. A method according to claim 15, wherein the electrically conducting materials are arranged on the longitudinal axis of the cut blank and of the subsequent fuse and are surrounded coaxially by the electrically insulating materials.

17. A method according to claim 15, wherein plastics materials, to which suitable additives are added, are used for the electrically conducting materials and electrically insulating materials.

18. A method according to claim 17, wherein electrically conductive materials are added to the plastics materials so that they become electrically conducting.

19. A method according to claim 18, wherein the electrically conductive materials are selected from the group consisting of copper, silver, gold or conductive ceramic materials and carbon.

20. A method according to claim 18, wherein the electrically conductive materials are metal particles.

21. A method according to claim 18, wherein electrically conductive powder is used for the electrically conductive metal particles.

22. Method according to claim 17, wherein thermally conducting ceramic particles are added to the electrically insulating plastics materials.

23. A method according to claim 21, wherein the thermally conducting particles are a ceramic comprising at least one compound selected from the group consisting of Al₂O₃, ZrO₂, SiO₂ and AlN.

24. A method according to claim 15, wherein the electrically insulating plastics materials are selected from the group consisting of PEEK, Teflon and polyethylene.

25. A method according to claim 15 wherein multi-component composites are used for the plastics materials.

26. A method according to claim 24, wherein a plastics material that is filled with quartz sand is used for the electrically insulating plastics materials.

27. A method according to claim 15, wherein materials are used that terminate the melting of the conductive materials and plastics materials in the case of overloading.

28. An electrical fuse having an electrically conducting material that is enclosed by a electrically insulating material and having electrically conducting terminal elements to the electrically conducting material produced by a method according to claim 15, wherein the materials are plastics materials, to which electrically conducting or thermally conducting additives are added.

29. A blank for producing an electrical fuse with electrically conducting materials that are enclosed by electrically insulating materials for subsequent assembly and supplementation with electrically conducting terminal elements to the electrically conducting materials wherein the material are plastics materials, to which electrically conducting and/or thermally conducting additives are added.
